(19) United States
(12) Patent Application Publication
(10) Pub. No.: US 2025/0376328 A1
(43) Pub. Date: Dec. 11, 2025

(54) IMPROVED SWITCHING FROM AN ENERGY SAVING MODE INTO A NORMAL OPERATING MODE IN A PICKING SYSTEM

(71) Applicant: TGW Logistics GmbH, Marchtrenk (AT)

(72) Inventors: Alexander Franz BAUMAN, Meggenhofen (AT); Thomas Bernhard PICHELSBERGER, Bad Zell (AT); Arnold Franz TRINKL, Pichl bei Wels (AT)

(73) Assignee: TGW Logistics GmbH, Marchtrenk (AT)

(21) Appl. No.: 18/878,489

(22) PCT Filed: Jun. 28, 2023
(86) PCT No.: PCT/AT2023/060205

§ 371 Date: Dec. 23, 2024

(30) Foreign Application Priority Data
Jun. 30, 2022 (AT) A 50478/2022

(51) Int. Cl. B65G 1/137; B65G 43/00

(52) U.S. Cl. CPC B65G 1/1378; B65G 43/00

(57) ABSTRACT

A picking system and method includes an article storage, a picking station, a conveying system, a drive system, a control system and an energy supply system. The picking system further comprises an electronic energy saving module, with which the picking system can be switched from a normal operating mode to an energy saving mode and vice versa. The energy saving module is further configured for a) masking, suppressing or automatically acknowledging error messages when switching from the energy saving mode to the normal operating mode, and/or b) suppressing or automatically acknowledging error diagnosis functions or troubleshooting functions when switching from the energy saving mode to the normal operating mode, and/or c) providing an error message acknowledgement element when switching from the energy saving mode to the normal operating mode, by means of which multiple error messages can be acknowledged at the same time.

### BACKGROUND

The disclosure relates to a picking system with an article storage, a picking station, a conveying system for transporting articles between the article storage and the picking station, a drive system for the conveying system, a control system for the conveying system and an energy supply system, which is configured for supplying the drive system and the control system with energy. The picking system further comprises an electronic energy saving module, with which the picking system can be switched from a normal operating mode to an energy saving mode and from the energy saving mode to the normal operating mode, wherein in the energy saving mode, at least a part of the energy supply system is switched off. Further, the disclosure relates to a method for operating a picking system of the above-mentioned kind, and in particular for switching from an energy saving mode to a normal operating mode, wherein in the energy saving mode, at least a part of the energy supply system is switched off.

While suggestions have been made for an energy saving mode in a picking system in the prior art, the energy saving mode is used little or not at all by the operating personnel for the picking system due to the complexity of the start-up operation. If at all, the energy saving mode is used only for relatively long standstills because of the effortful start-up operation. The goal of the energy saving mode is therefore not achieved, or achieved only insufficiently.

### OVERVIEW

It is therefore an object of the disclosure to specify an improved picking system and an improved method for switching from an energy saving mode to a normal operating mode. In particular, the disadvantages specified above are to be overcome and the usability of an energy saving mode in a picking system is to be improved.

The technical problem raised is solved by a picking system of the kind mentioned in the beginning, in which the energy saving module is configured for
a) masking, suppressing or automatically acknowledging error messages when switching from the energy saving mode to the normal operating mode, and/or
b) suppressing or automatically acknowledging error diagnosis functions or troubleshooting functions when switching from the energy saving mode to the normal operating mode, and/or
c) providing an error message acknowledgement element when switching from the energy saving mode to the normal operating mode, by means of which multiple error messages can be acknowledged at the same time.

Further, the technical problem raised is solved by a method of the kind mentioned in the beginning, in which
the picking system is switched from the energy saving mode to the normal operating mode with an electronic energy saving module, and
a) error messages are masked, suppressed or automatically acknowledged by the energy saving module when switching from the energy saving mode to the normal operating mode, and/or
b) error diagnosis functions or troubleshooting functions are suppressed or automatically acknowledged by the energy saving module when switching from the energy saving mode to the normal operating mode, and/or
c) an error message acknowledgement element is provided by the energy saving module when switching from the energy saving mode to the normal operating mode, by means of which multiple error messages can be acknowledged at the same time.

The proposed measures have the effect that the picking system can be easily transferred from the energy saving mode to the normal operating mode without effortful start-up procedures and extensive interventions on the part of the operating personnel for the picking system being required. In particular, an automatic start-up of the picking system when switching from the energy saving mode to the normal operating mode is enabled. Therefore, the picking system can be set to an energy saving mode even for relatively short periods of time without this causing major disruptions in the picking procedure. Overall, the proposed measures therefore contribute to a lower energy consumption in a picking system as compared to the prior art. Furthermore, the proposed measures ensure that a software for operating a picking system need not be modified, or need be modified only slightly. This enables the comfortable switching from the energy saving mode to the normal operating mode to be implemented with a low effort, too, even in existing picking systems.

The energy saving module can comprise software and/or hardware and in particular be configured as a master computer, or part of a master computer, with integrated switching elements for switching the energy supply system or switching elements which are connected to the master computer via control lines. The switching elements for switching the energy supply system can in particular be configured as relays or contactors. The switching elements can be switched on or off using corresponding switching commands by the master computer. In a similar manner, the error message acknowledgement element can be formed by a physical switching element, i.e. for example by a mechanical switch or pushbutton.

Preferably, the energy saving module comprises a software module, by means of which the picking system can be switched to the energy saving mode. Particularly preferably, the software module comprises a graphic user interface which has a button, wherein the picking system can be switched to the energy saving mode by actuating the button. Here, the button can be configured such that it is actuated by clicking on the button, by pulling the button along a predefined (displayed) path or suchlike. In the same manner, the error message acknowledgement element can be formed by another such button.

The conveying system can comprise a storage and/or retrieval conveying system (e.g. storage and retrieval units or shuttles), stationary conveying system and/or mobile conveying system.

The electronic energy saving module is used to switch in particular electrical energy away from the picking system or parts thereof, yet the electronic energy saving module also relates to the saving of other forms of energy. For example, the energy saving module can also switch pneumatic energy away from the picking system or parts thereof.

An “error message” indicates an error in the picking system. In particular, an error message can be actively generated by the unit in which the error occurs. For example, an error message can indicate the failure of a drive component and also be generated by this drive component.

An “error diagnosis function” is in particular a function which is realized in software and/or hardware and can be executed for diagnosing any error in the picking system. An error diagnosis function, therefore, serves in particular to collect errors which are not actively generated. For example, the proper functioning or the failure, as the case may be, of a drive component can be verified in this manner.

A “troubleshooting function” is in particular a function which is realized in software and/or hardware and can be executed for correcting an error in the picking system. For example, the software of a drive component can be restarted by a troubleshooting function in order to possibly correct an existing error.

“Masking” an error message means in particular that, while the error message is generated, it is not displayed to the operating personnel of the picking system.

“Suppressing” an error message means in particular that the error message is not generated. Analogously, “suppressing” an error diagnosis function or troubleshooting function means that this function is not executed.

“Automatically acknowledging” an error message means in particular that, while the error message is generated and may even be even displayed, it is automatically confirmed without intervention by the operating personnel of the picking system. Analogously, “automatically acknowledging” an error diagnosis function or troubleshooting function means in particular that, while this function is executed, it is automatically confirmed without intervention by the operating personnel of the picking system.

The “acknowledging at the same time” of multiple error messages with the help of the error message acknowledgement element constitutes an automated possibility to confirm error messages. While this variant requires the intervention by the operating personnel of the picking system, the confirmation of the error messages is simple for the operating personnel, as multiple error messages at once can be confirmed with only one actuation of the error message acknowledgement element. Here, the term “at the same time” refers to the operation of actuating the error message acknowledgement element. The individual error messages per se can thereby be acknowledged at the same time, but also a chronological sequence of acknowledgements of individual error messages is conceivable. This is in particular helpful whenever error messages depend on one another and can only be acknowledged or confirmed in a specific sequence. This means that the acknowledgement of the error messages per se can also extend over a specific period of time. In this sense, the term “at the same time” can be understood in the given context as synonymous with “all at once” or “by a single actuation of the error message acknowledgement element.”

The embodiment variants presented can be used alone or in any combination. For example, it is conceivable that either only variant a), only variant b) or only variant c) is used. Also the optional use of one of multiple generally available variants would be possible. Yet it is also conceivable that variant a) is used for one part of the error messages and variant c) for another part.

Similar considerations can be made at the level of the terms “masking,” “suppressing,” “automatically acknowledging” and “acknowledging at the same time” (and/or “automated acknowledging”). For example, it is conceivable, again, that generally only one of the specified variants is used or one of multiple generally available variants can be selected. Yet it is also conceivable that one variant is used for one part of the error messages and another variant for another part.

Further advantageous designs and further advancements of the disclosure result from the subclaims as well as from the description in combination with the figures.

It is advantageous
if the control system comprises a submodule with a voltage monitoring device, which detects a failure of a supply voltage for the submodule and displays the failure of a supply voltage by an error message also after the supply voltage has been switched on again, and
if the energy saving module
a) masks, suppresses and/or automatically acknowledges error messages relating to said failure of the supply voltage when switching from the energy saving mode to the normal operating mode, and/or
b) suppresses or automatically acknowledges error diagnosis functions relating to said failure of the supply voltage when switching from the energy saving mode to the normal operating mode, and/or
c) provides an error message acknowledgement element when switching from the energy saving mode to the normal operating mode, by means of which multiple error messages relating to said failure of the supply voltage can be acknowledged at the same time.

It is equally advantageous if the energy saving module is configured for executing the steps a) and/or b) and/or c).

Submodules of the control system can comprise a voltage monitoring device, which detects a failure of a supply voltage for the submodule and displays this failure by an error message after the supply voltage has been switched on again. This is to prevent inexplicable errors in the respective part of the control system due to a temporary drop in the supply voltage. Instead, a failure of a supply voltage can be identified at any time, even if it is only temporary. Errors which can be attributed to such a failure of a supply voltage can therefore be assigned accordingly. In an energy saving mode, such generally expedient voltage monitoring devices, if unaccompanied by other measures, will result in an abundance of error messages occurring and/or in an abundance of error diagnosis functions being executed in a picking system when switching from the energy saving mode to the normal operating mode. These error messages and/or error diagnosis functions must be acknowledged to ensure proper operation of the picking system after switching from the energy saving mode to the normal operating mode. However, this is highly time-consuming for the operating personnel of the picking system, so that the energy saving mode in the prior art is used little or not at all, as mentioned above. The proposed measures, in contrast, effect a substantial facilitation, as error messages which can be attributed to a failure of the supply voltage knowingly caused by switching to the energy saving mode can be masked, suppressed and/or automatically acknowledged and/or be manually acknowledged in a simple manner by the error message acknowledgement element when switching from the energy saving mode to the normal operating mode. Equally, error diagnosis functions which can be attributed to a failure of the supply voltage knowingly caused by switching to the energy saving mode are suppressed or automatically acknowledged when switching from the energy saving mode to the normal operating mode. Said submodule of the control system can be a control module or a measurement module, for example.

Generally, the provisioning of a voltage monitoring device for detecting a failure of a supply voltage for a submodule is not a basic requirement. It is also conceivable, for example, that a voltage failure for a submodule is (indirectly) detected by the submodule no longer being accessible via a communication channel. A corresponding error message can then be generated in the control system. It is also conceivable that, during a drop in the supply voltage, a corresponding error message is transmitted by the submodule just before it fails.

It is advantageous
if the picking system is divided into spatially limited zones, each of which is supplied with energy by the energy supply system in the normal operating mode, and
if the energy saving module is configured for switching one, multiple or all zones of the zones from the normal operating mode to the energy saving mode and from the energy saving mode to the normal operating mode as required, wherein in the energy saving mode, at least the part of the energy supply system which supplies the respective zone or zones with energy is switched off,
and if the energy saving module is configured for
a) masking, suppressing or automatically acknowledging error messages assigned to the zone when switching the zone from the energy saving mode to the normal operating mode, and/or
b) suppressing or automatically acknowledging error diagnosis functions or troubleshooting functions assigned to the zone when switching the zone from the energy saving mode to the normal operating mode, and/or
c) providing an error message acknowledgement element when switching from the energy saving mode to the normal operating mode, by means of which multiple error messages assigned to the zone can be acknowledged at the same time.

It is equally advantageous if the energy saving module is configured for executing the abovementioned steps.

For example, the zones can be formed by or comprise functional groups of the picking system, for example a picking zone, a storage zone, a transport zone, a sorting zone and suchlike. A zone can have a virtual limit and/or be limited in full or in part by construction measures, wherein an access to the zone by a person is enabled only at a passage. Such construction measures are in particular walls but also other means in the picking system which cannot be passed by persons, or are at least not provided for being passed by a person. For example, scaffolding, grids, fences and similar, which, while generally being able to be climbed through or over, are not provided for that purpose, are construction measures that are not provided for being passed by a person. An access by a person to a zone that is limited by construction measures can be enabled at a passage or only at a passage. Such passages are, for example, corresponding wall cutout openings, doors, gates and suchlike.

It is favorable if the energy saving module comprises multiple energy switching modules, each of which is assigned to a zone of the zones, wherein one or multiple zones are switched from the normal operating mode to the energy saving mode and from the energy saving mode to the normal operating mode, as required, by the respectively assigned energy switching module. It is equally favorable if the energy saving module comprises multiple energy switching modules, each of which is assigned to a zone of the zones and is configured for switching the respective zone from the normal operating mode to the energy saving mode and from the energy saving mode to the normal operating mode as required. In this embodiment variant, the energy saving module is structured hierarchically. The structure, operation and maintenance of the energy saving module can thereby be facilitated. If the energy saving module comprises a software module, the energy switching modules can be configured as software submodules, for example. It is equally conceivable that the energy switching modules are each implemented as a button described above, so that one button each is assigned to one zone of the zones each.

It is particularly advantageous
if the picking system comprises an integrity monitoring device, which monitors an integrity of the zone in the energy saving mode, wherein the integrity of the zone is violated at least whenever the integrity monitoring device detects an access to the zone by a person, and
if the energy saving module
a) displays error messages assigned to the zone at an output device when switching the zone from the energy saving mode to the normal operating mode if the integrity of the zone is violated when switching as specified, and masks, suppresses and/or automatically acknowledges error messages assigned to the zone if the integrity of the zone is inviolate when switching as specified, and/or
b) executes error diagnosis functions or troubleshooting functions assigned to the zone when switching the zone from the energy saving mode to the normal operating mode if the integrity of the zone is violated when switching as specified, and suppresses or automatically acknowledges their execution if the integrity of the zone is inviolate when switching as specified, and/or
c) displays error messages assigned to the zone at an output device when switching the zone from the energy saving mode to the normal operating mode if the integrity of the zone is violated when switching as specified, and provides an error message acknowledgement element when switching from the energy saving mode to the normal operating mode, by means of which multiple error messages assigned to the zone can be acknowledged at the same time if the integrity of the zone is inviolate when switching as specified.

It is equally advantageous if the energy saving module is configured for executing the steps a) and/or b) and/or c).

In case of a division into zones and during their selective switching to the energy saving mode, generally expedient error messages and error diagnosis functions or troubleshooting functions, if unaccompanied by other measures, will result in an abundance of error messages occurring and/or an abundance of error diagnosis functions being executed in a picking system when switching from the energy saving mode to the normal operating mode. These error messages and/or error diagnosis functions must be acknowledged in order to ensure proper operation of the picking system after switching from the energy saving mode to the normal operating mode. However, this is highly time-consuming for the operating personnel of the picking system, so that the energy saving mode in the prior art is used little or not at all, as mentioned above. The proposed measures, in contrast, effect a substantial facilitation, as it is assumed that error messages assigned to the zone and/or error diagnosis functions or troubleshooting functions assigned to the zone are irrelevant if the integrity of the zone is inviolate when switching as specified, i.e. if the zone in the energy saving mode was not entered by a person, for example. Therefore, error messages occurring in the energy saving mode are masked, suppressed and/or automatically acknowledged when switching from the energy saving mode to the normal operating mode and/or can be manually acknowledged in a simple manner by the error message acknowledgement element if the integrity of the zone is inviolate when switching as specified. Equally, error diagnosis functions occurring in the energy saving mode are suppressed or automatically acknowledged when switching from the energy saving mode to the normal operating mode if the integrity of the zone is inviolate when switching as specified.

The specification “if the integrity of the zone is violated when switching as specified” means in particular “if the integrity monitoring device displays a violation of the integrity of the zone when switching as specified.” For example, a flag or status bit can be set in the integrity monitoring device or a switching element can be switched on if the integrity of the zone is violated. In the latter case, a violation of the integrity can be displayed, for example, by a specific voltage level or a specific signal. The integrity monitoring device can be configured both in software and in hardware and accordingly comprise a computer program and/or an electronic circuit.

An integrity monitoring device can also be configured for triggering an (automatic) switching from the energy saving mode to the normal operating mode. This enables, for example, a start-up operation for the zone to be initiated whenever a person in charge of the operation of the zone enters the zone, for example the morning after a nighttime standstill of the zone. The proposed measures ensure that the zone can become operational again particularly quickly and comfortably. The triggering of the switching operation can also be provided for a specific window of time only, for example from 7:00 a.m. to 9:00 a.m. If a violation of the integrity is established before this window of time (i.e. in the present example before 7:00 a.m.), there will be no automatic triggering.

It is also conceivable that specific integrity monitoring devices of the zone (immediately) trigger a displaying of the error messages (cases a) and c)) occurred in the zone and/or trigger an execution of the error diagnosis functions or troubleshooting functions assigned to the zone (case b)) if the integrity is violated. In particular, a displaying of the error messages and/or execution of the error diagnosis functions or troubleshooting functions which are assigned to be detected by the integrity monitoring device can be triggered. This enables cases of violation of the integrity which are classified particularly severe to be treated separately. For example, this can be the case if a penetration of a zone from outside of the picking system is established.

It is further advantageous
if the control system comprises a submodule with a voltage monitoring device, which detects a failure of a supply voltage for the submodule and displays the failure of a supply voltage by an error message also after the supply voltage has been switched on again, and
if the energy saving module
a) masks, suppresses and/or automatically acknowledges error messages assigned to the zone and relating to said failure of the supply voltage when switching the zone from the energy saving mode to a normal operating mode, and/or
b) suppresses or automatically acknowledges error diagnosis functions assigned to the zone and relating to said failure of the supply voltage when switching the zone from the energy saving mode to the normal operating mode, and/or
c) provides an error message acknowledgement element when switching from the energy saving mode to the normal operating mode, by means of which multiple error messages assigned to the zone and relating to said failure of the supply voltage can be acknowledged at the same time.

It is equally advantageous if the energy saving module is configured for executing the steps a) and/or b) and/or c).

In this embodiment variant, the measures proposed for a voltage monitoring device and for a zone and/or the resultant advantages are combined.

It is particularly advantageous
if the picking system a comprises an integrity monitoring device, which monitors an integrity of the zone in the energy saving mode, wherein the integrity of the zone is violated at least whenever the integrity monitoring device detects an access to the zone by a person,
if the control system comprises a submodule with a voltage monitoring device, which detects a failure of a supply voltage for the submodule and displays the failure of a supply voltage by an error message also after the supply voltage has been switched on again, and
if the energy saving module
a) displays error messages assigned to the zone, including error messages relating to said failure of the supply voltage, when switching the zone from the energy saving mode to the normal operating mode if the integrity of the zone is violated when switching as specified, and masks, suppresses and/or automatically acknowledges error messages assigned to the zone, including error messages relating to said failure of the supply voltage, if the integrity of the zone is inviolate when switching as specified, and/or
b) executes error diagnosis functions or troubleshooting functions assigned to the zone, including error diagnosis functions relating to said failure of the supply voltage, when switching the zone from the energy saving mode to the normal operating mode if the integrity of the zone is violated when switching as specified, and suppresses or automatically acknowledges their execution if the integrity of the zone is inviolate when switching as specified, and/or
c) displays error messages assigned to the zone, including error messages relating to said failure of the supply voltage, when switching the zone from the energy saving mode to a normal operating mode if the integrity of the zone is violated when switching as specified, and provides an error message acknowledgement element when switching from the energy saving mode to the normal operating mode, by means of which multiple error messages assigned to the zone, including error messages relating to said failure of the supply voltage, can be acknowledged at the same time if the integrity of the zone is inviolate when switching as specified. It is equally advantageous if the energy saving module is configured for executing the steps above.

In this embodiment variant, the measures proposed for a voltage monitoring device and for an integrity monitoring device and/or the resultant advantages are combined, wherein the error messages relating to said failure of the supply voltage are treated the same as all other error messages in this embodiment variant.

It is also particularly advantageous
if the picking system comprises an integrity monitoring device, which monitors an integrity of the zone in the energy saving mode, wherein the integrity of the zone is violated at least whenever the integrity monitoring device detects an access to the zone by a person,
if the control system comprises a submodule with a voltage monitoring device, which detects a failure of a supply voltage for the submodule and displays the failure of a supply voltage by an error message also after the supply voltage has been switched on again, and
if the energy saving module
a) displays error messages assigned to the zone, excluding error messages relating to said failure of the supply voltage, when switching the zone from the energy saving mode to a normal operating mode if the integrity of the zone is violated when switching as specified, and masks, suppresses and/or automatically acknowledges error messages assigned to the zone, excluding error messages relating to said failure of the supply voltage, if the integrity of the zone is inviolate when switching as specified, and masks, suppresses and/or automatically acknowledges error messages assigned to the zone and relating to said failure of the supply voltage when switching the zone from the energy saving mode to a normal operating mode independent of the integrity of the zone when switching as specified, and/or
b) executes error diagnosis functions or troubleshooting functions assigned to the zone, excluding error diagnosis functions relating to said failure of the supply voltage, when switching the zone from the energy saving mode to the normal operating mode if the integrity of the zone is violated when switching as specified, and suppresses or automatically acknowledges their execution if the integrity of the zone is inviolate when switching as specified, and suppresses or automatically acknowledges error diagnosis functions assigned to the zone and relating to said failure of the supply voltage when switching the zone from the energy saving mode to the normal operating mode independent of the integrity of the zone when switching as specified, and/or
c) displays error messages assigned to the zone, excluding error messages relating to said failure of the supply voltage, when switching the zone from the energy saving mode to a normal operating mode if the integrity of the zone is violated when switching as specified, and provides an error message acknowledgement element when switching from the energy saving mode to the normal operating mode, by means of which multiple error messages assigned to the zone, excluding error messages relating to said failure of the supply voltage, can be acknowledged at the same time if the integrity of the zone is inviolate when switching as specified, and by means of which multiple error messages assigned to the zone and relating to said failure of the supply voltage can be acknowledged independent of the integrity of the zone when switching as specified.

It is equally advantageous if the energy saving module is configured for executing the steps above.

In this embodiment variant, the measures proposed for a voltage monitoring device and for an integrity monitoring device and/or the resultant advantages are combined again, wherein the error messages relating to said failure of the supply voltage, however, are treated differently from all other error messages in this embodiment variant. In particular, error messages assigned to the zone which can be attributed to a failure of the supply voltage knowingly caused by switching to the energy saving mode are always masked, suppressed and/or automatically acknowledged when switching from the energy saving mode to the normal operating mode. Equally, error diagnosis functions which can be attributed to a knowingly caused failure of the supply voltage are always suppressed or automatically acknowledged when switching from the energy saving mode to the normal operating mode.

It is also particularly advantageous if an integrity acknowledgement element is provided, which resets a violated integrity of the zone upon actuation, and/or which is configured for resetting a violated integrity of the zone upon actuation. This enables persons who enter a zone in an energy saving mode but ensure that no changes were made in the zone to reset a violated integrity. For example, such a person can be a night porter inspecting a zone. The integrity acknowledgement element can be designed, for example, as an acknowledgement button or acknowledgement function and configured both in software and in hardware. What has been said in relation to the design of the error message acknowledgement element in the form of a physical switching element and/or in relation to the switching elements of the energy saving module analogously applies here. What has been said in relation to the design of the error message acknowledgement element in the form of a button and/or in relation to the graphic user interface of the energy saving module also analogously applies.

It is favorable if the integrity monitoring device for the monitoring of an access to the zone by a person in the energy saving mode comprises a door switch, a light barrier, a light grid, a surveillance camera and/or a motion detector. This puts proven and easily available means for monitoring an integrity of a zone to use.

It is further particularly advantageous if
the integrity monitoring device comprises an emergency stop and/or emergency shutdown actuating element acting upon the energy supply of the zone, and
the integrity of the zone is violated and remains violated when the emergency stop and/or emergency shutdown actuating element is pushed even once the emergency stop and/or emergency shutdown actuating element is unlocked again.

The actuation of an emergency stop and/or emergency shutdown actuating element often results from a serious error in the procedures in a picking system. To prevent further damage, persons who notice such an error can shut down relevant parts of the picking system. While emergency stop and/or emergency shutdown actuating elements are generally expedient means, their actuation in the energy saving mode will have no consequence if the relevant plant parts of the picking system are switched current-free anyway. Nevertheless it can be useful not to ignore such an event, as it can be assumed that the actuation was preceded by the observation of an error after all. In this embodiment variant, it is therefore provided that the integrity of the zone is violated and remains violated even once the emergency stop and/or emergency shutdown actuating element is unlocked again.

Alternatively, it is particularly advantageous if
the integrity monitoring device comprises an emergency stop and/or emergency shutdown actuating element acting upon the energy supply of the zone, and
the integrity of the zone is violated only as long as the emergency stop and/or emergency shutdown actuating element is pushed or locked.

This embodiment variant is very similar to the aforementioned embodiment variant. However, in this case, it is assumed that the actuation of the emergency stop and/or emergency shutdown actuating element is relevant only as long as the emergency stop and/or emergency shutdown actuating element is pushed or locked. In this embodiment variant, it is therefore provided that the integrity of the zone is violated only as long as the emergency stop and/or emergency shutdown actuating element is pushed or locked. Once the emergency stop and/or emergency shutdown actuating element is released or unlocked, the integrity of the zone is restored.

Within the scope of this disclosure, “emergency stop” is in particular the stopping of moving means without the energy input to this means necessarily being (completely) interrupted. For example, a drive motor can be switched off and an electromagnetic brake actuated at the same time. In such a manner, a hazard posed by moving parts can be averted but not necessarily a hazard posed by the energy supply per se.

Within the scope of this disclosure, “emergency shutdown” is in particular the interruption of an energy input without necessarily actively stopping a movement of moving means. For example, a drive motor can be switched off without being braked. Accordingly, a hazard posed by the energy supply per se can be averted but not necessarily a hazard posed by moving means.

Hazards posed by an energy supply per se and hazards posed by moving means can be excluded by a combined emergency stop and emergency shutdown actuating element. It should therefore be noted that the individual designations are not sharply distinguished in practice, so that the assignment of functions described above need not necessarily apply.

Generally, the emergency stop and/or emergency shutdown actuating element can be configured, for example, as an emergency stop and/or emergency shutdown switch or as an emergency stop and/or emergency shutdown pushbutton. This includes especially physical actuating elements which serve this purpose only, for example actuating elements with a yellow housing and a red mushroom head for actuation. Yet also buttons on a screen with push or switching function, for example, which can be actuated with a computer mouse, or in case of a touch screen with a finger, would also be conceivable for the same purpose.

It is favorable if the picking system additionally comprises a safety system supplied with energy by the energy supply system, wherein in the energy saving mode, at least part of the energy supply system for the safety system is switched off. Such a safety system can be, for example, a light curtain which monitors the access to a safety area around a robot. If such a light curtain and/or safety area is in the energy saving mode in a zone, also this safety system can safely be deactivated, as the robot, once switched current-free, poses no hazard. A safety system which acts not only upon the switched-off zone, in contrast, can remain switched on. For example, this may be parts of an alarm system with which the picking system is monitored.

It is favorable if the energy saving module
a) masks, suppresses and/or automatically acknowledges all error messages, in particular all error messages assigned to a zone, when switching from the energy saving mode to a normal operating mode, and/or
b) suppresses or automatically acknowledges all error diagnosis functions or troubleshooting functions, in particular all error diagnosis functions or troubleshooting functions assigned to a zone, when switching from the energy saving mode to the normal operating mode, and/or
c) provides an error message acknowledgement element when switching from the energy saving mode to the normal operating mode, by means of which all error messages, in particular all error messages assigned to a zone, can be acknowledged at the same time.

It is equally favorable if the energy saving module is configured for executing the steps a) and/or b) and/or c).

This enables the switching from the energy saving mode to the normal operating mode to be executed with a particularly low effort.

Alternatively, it is favorable if the picking system
comprises a selecting module, which acquires a selection of error messages, error diagnosis functions or troubleshooting functions, in particular a selection of error messages, error diagnosis functions or troubleshooting functions which are assigned to a zone, and
if the energy saving module
a) excepts the selected error messages from being masked, suppressed or automatically acknowledged when switching from the energy saving mode to a normal operation, and/or
b) excepts the selected error diagnosis functions or troubleshooting functions from being suppressed or automatically acknowledged when switching from the energy saving mode to the normal operation, and/or
c) provides an error message acknowledgement element when switching from the energy saving mode to the normal operating mode, wherein the selected error messages are excepted from being acknowledged by the error message acknowledgement element at the same time. It is equally favorable if the energy saving module is configured for executing the steps a) and/or b) and/or c).

Therefore, in an input mask of the selecting module, those error messages which are not to be masked, suppressed or automatically acknowledged and/or are not to be acknowledgeable by the error message acknowledgement element when switching from the energy saving mode to a normal operation can be actively selected in cases a) and c) and those error diagnosis functions or troubleshooting functions which are not to be suppressed or automatically acknowledged when switching from the energy saving mode can be actively selected in case b). Points a), b) and c) can also relate to a negative selection (i.e. deselection), for example if, in an input mask of the selecting module, those error messages which are to be masked, suppressed or automatically acknowledged and/or are to be acknowledgeable by the error message acknowledgement element when switching from the energy saving mode to a normal operation are actively selected in cases a) and c) and those error diagnosis functions or troubleshooting functions which are to be suppressed or automatically acknowledged when switching from the energy saving mode are actively selected in case b).

It is favorable if, in the respective step c) in the described methods, multiple error messages are acknowledged at the same time by the provided error message acknowledgement element, in particular by an operator.

For the purpose of better understanding of the disclosure, it will be elucidated in more detail by means of the figures below.

### BRIEF DESCRIPTION OF THE FIGURES

The figures show in a respectively very simplified schematic representation:

FIG. 1 schematically an exemplary picking system in a top view;

FIG. 2 a somewhat more detailed schematic representation of a part of the picking system, including its electrical supply;

FIG. 3 like FIG. 2, only with an emergency stop and/or emergency shutdown actuating element in the supply line; and

FIG. 4 a circuit diagram of an exemplary voltage monitoring device.

### DETAILED DESCRIPTION OF THE EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and, in case of a change of position, are to be analogously transferred to the new position.

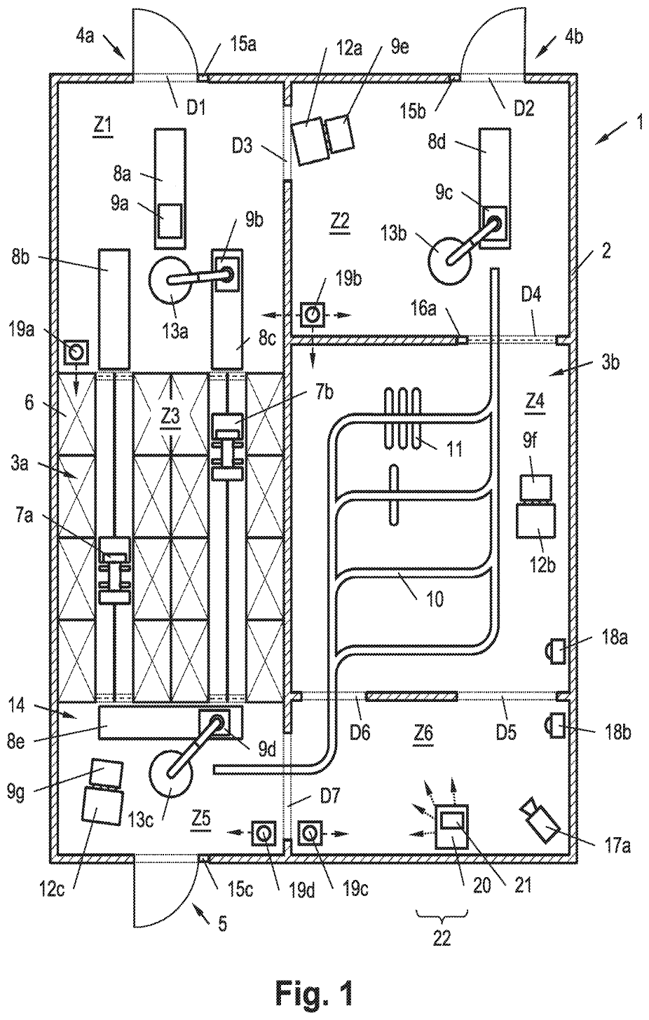

FIG. 1 schematically shows an exemplary picking system 1 in a top view. The picking system 1 is located in a building and comprises multiple walls 2. The picking system 1 can further comprise an article storage 3a for lying articles and/or an article storage 3b for hanging articles. Yet the provisioning of two different article storages 3a, 3b is not mandatory and should be understood as purely exemplary. In addition, the picking system 1 preferably comprises article receipts 4a, 4b and an article issue 5. In the article storage 3a, multiple racks 6 and storage and retrieval units 7a, 7b moving therebetween are provided. Between the article receipt 4a and the article storage 3a, there are multiple conveyors 8a . . . 8c. In the region of the article receipt 4b, there is another conveyor 8d. Between the article storage 3a and the article issue 5, there is finally a conveyor 8e. Purely by way of example, lying articles 9a . . . 9d are located on the conveyors 8a, 8b, 8d and 8e. The article storage 3b comprises an overhead conveyor 10, on which hanging articles 11 can be stored and/or transported. The article storage 3b is connected, in terms of conveyance, with the conveyor 8d and the conveyor 8e. The picking system 1 can further comprise multiple autonomous guided vehicles 12a . . . 12c, which transport the articles 9e . . . 9g by way of example. Furthermore, the picking system 1 comprises multiple robots 13a . . . 13c, which are provided for manipulating the lying articles 9a . . . 9g and/or for manipulating the hanging articles 11. Specifically, the robot 13a forms the connection, in terms of conveyance, between the conveyors 8a . . . 8c and the guided vehicles 12a . . . 12c, the robot 13b forms the connection, in terms of conveyance, between the conveyor 8d, the overhead conveyor 10 and the guided vehicles 12a . . . 12c, and the robot 13c forms the connection, in terms of conveyance, between the conveyor 9d, the overhead conveyor 10 and the guided vehicles 12a . . . 12c.

Lying articles 9e . . . 9g can be delivered via the article receipt 4a, transported to the robot 13a using the conveyor 8a and reloaded onto the conveyors 8b, 8c from there. On the conveyors 8b, 8c, the lying articles 9e . . . 9g can be transported to the store 3a and stored in the storage racks 6 there using the storage and retrieval units 7a, 7b. In a similar manner, hanging articles 11 can be delivered at the article receipt 4b, transported to the robot 13b using the conveyor 8d and reloaded onto the overhead conveyor 10 from there. Subsequently, the hanging articles 11 can be transported, on the overhead conveyor 10, to the store 3b and stored there. Furthermore, lying articles 9e . . . 9g and hanging articles 11 can also be transported from the article receipts 4a, 4b to one of the conveyors 8a . . . 8d, to one of the robots 13a, 13b, to the storage areas 3a, 3b or also to the article issue 5 using the guided vehicles 12a . . . 12c.

When picking (customer) orders, the required lying articles 9e . . . 9g are retrieved from the storage racks 6 using the storage and retrieval units 7a, 7b, transported to the robot 13c using the conveyor 9d and picked into a shipping unit by the robot 13c. In the same manner, hanging articles 11 can be transported to the robot 13c via the overhead conveyor 10 and picked into a shipping unit by the robot 13c. In addition, it is also possible that lying articles 9e . . . 9g and/or hanging articles 11 are transported from the article receipts 4a, 4b directly to the robot 13c using the guided vehicles 12a . . . 12c and picked into a shipping unit by the robot 13c.

The procedures above are generally known and are therefore not described in more detail.

Preferably, the picking system 1 is subdivided into multiple zones Z1 . . . Z6, as represented in

FIG. 1 by way of example. In particular, the zones Z1 . . . Z6 can be entered and left via the article receipts 4a, 4b, the article issue 5 and the passages D1 . . . D7. The zones Z1, Z2 form goodsin areas, the zones Z3, Z4 form storage areas, the zone Z5 forms a picking area and/or a picking station 14 and the zone Z6 forms a general article manipulation area.

Door switches 15a . . . 15c can be provided at a door, as represented for the doors at the article receipts 4a, 4b and the article issue 5 by way of example. An opening of the respective door can thus be detected using the respective door switch 15a . . . 15c. In particular, an opening of the door at the article receipt 4a can be detected using the door switch 15a, an opening of the door at the article receipt 4b can be detected using the door switch 15b and an opening of the door at the article issue 5 can be detected using the door switch 15c.

It is further conceivable that a light barrier or a light grid 16a is provided at the passages D1 . . . D7, as shown at the passage D4 in FIG. 1. The light barrier or the light grid 16a represented in FIG. 1 can be used to detect an access to or leaving of the zones Z2, Z4. In general, the respective light barrier or the respective light grid 16a can be used to detect an access to or leaving of the respective zone Z1 . . . Z7. In addition, the zone Z3 can be secured with light barriers or light grids, whereby an access to or leaving of the zones Z1, Z3 or Z3, Z5 can be detected.

Furthermore, one or multiple surveillance cameras 17a can be installed in each of the zones Z1 . . . Z7, as represented by way of example for the zone Z6. Further, motion detectors 18a, 18b can be arranged in the zones Z1 . . . Z6, as shown by way of example for the zones Z4, Z6 in FIG. 1. The surveillance camera 17a and the motion detector 18b can be used to detect a person, an animal or another movement in the zone Z6. The motion detector 18a can be used to detect a person, an animal or another movement in the zone Z4.

Further, the picking system 1 can comprise multiple emergency stop and/or emergency shutdown actuating elements 19a . . . 19d, wherein it is indicated with arrows upon which zones Z1 . . . Z6 they act. In the example represented, the emergency stop and/or emergency shutdown actuating element 19a acts upon the zone Z3, the emergency stop and/or emergency shutdown actuating element 19b acts upon the zones Z1, Z2, Z4, the emergency stop and/or emergency shutdown actuating element 19c acts upon the zone Z6 and the emergency stop and/or emergency shutdown actuating element 19d acts upon the zone Z5.

Finally, the picking system 1 comprises a controller 20 with an energy saving module 21. The controller 20 can communicate with means in the picking system 1 in a wired and/or wireless manner, as indicated by arrows in FIG. 1. Together with the communication channels and/or communication lines, the controller 20 forms a control system 22. The energy saving module 21 can generally comprise software and/or hardware.

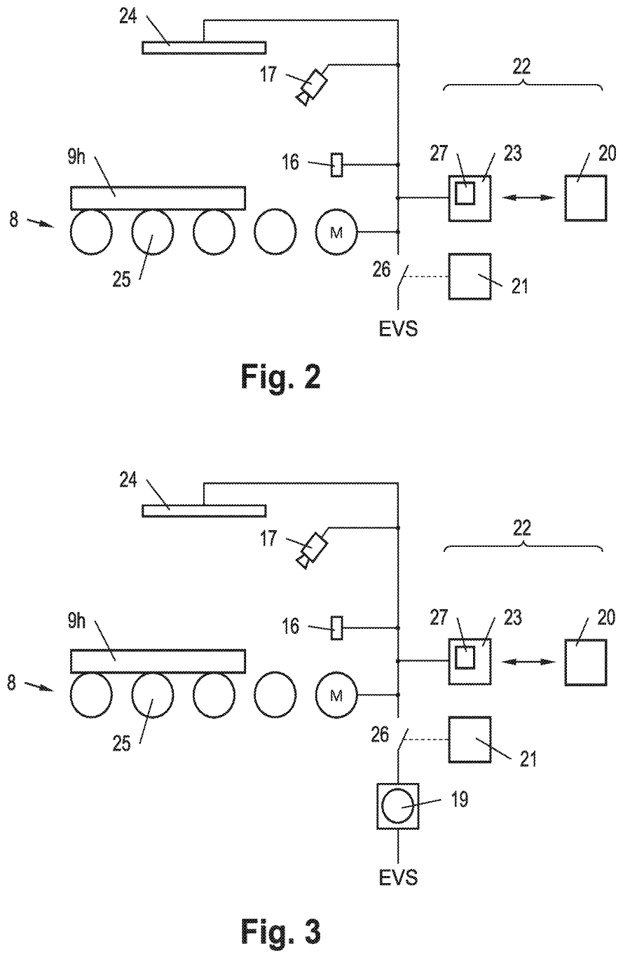

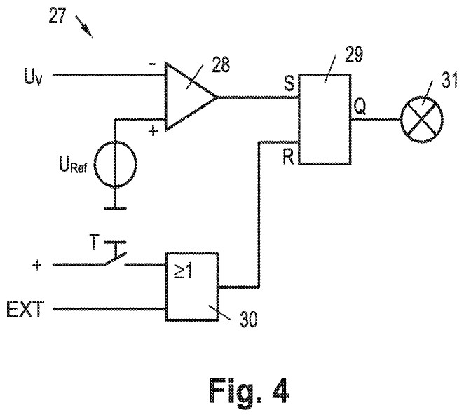

FIG. 2 shows a somewhat more detailed schematic representation of a part of the picking system 1 in a lateral view, in particular the electrical connection of a submodule 23 of the control system 22, an exemplary conveyor 8, a light barrier 16, a camera 17 and a lighting 24. In the example represented, the submodule 23, the drive M for conveyor rollers 25 of the conveyor 8, the light barrier 16, the camera 17 and the lighting 24 are connected to an energy supply system EVS, in particular to a power network, via a switch 26. Here, the switch 26 is controlled by the controller 20, specifically the energy saving module 21 of the controller 20. The switch 26 can in particular be configured as a relay or contactor. The switch 26 can be switched on or off by corresponding switching commands from the energy saving module 21. Here, the functional connection between energy saving module 21 and switch 26 can be realized in a wired or wireless manner. In this example, the submodule 23 of the control system 22 comprises also an optional voltage monitoring device 27 (see also FIG. 4). A wired or wireless communication between the submodule 23 and the controller 20 is symbolized by a double arrow in FIG. 2. It should also be noted in this context that, in FIG. 2, the focus is on the electrical supply and/or the connection to the energy supply system EVS, and communication channels between the submodule 23 and the light barrier 16, the camera 17 and the drive M are not explicitly represented but may be present in reality.

Generally, the picking system 1 therefore comprises, inter alia, an article storage 3a, 3b, a picking station 14, a conveying system for transporting articles 9e . . . 9g, 11 between the article storage 3a, 3b and the picking station 14, which comprises in particular the conveyors 8, 8a . . . 8c, the overhead conveyor 10 and the guided vehicles 12a . . . 12c in this example, a drive system for the conveying system 8, 8a . . . 8c, 10, 12a . . . 12c, which comprises the drive M and/or is symbolized by the drive M in this example, the control system 22 for the conveying system 8, 8a . . . 8c, 10, 12a . . . 12c and the energy supply system EVS, which is configured, inter alia, for supplying the drive system M and the control system 22 with energy.

The control system 22, in particular its energy saving module 21, is generally configured for switching the picking system 1 or parts thereof from a normal operating mode to an energy saving mode and from the energy saving mode to the normal operating mode, wherein in the energy saving mode, at least a part of the energy supply system EVS is switched off.

To enable an automatic start-up of the picking system 1 when switching from the energy saving mode to the normal operating mode, the energy saving module 21 is further configured for
a) masking, suppressing or automatically acknowledging error messages when switching from the energy saving mode to the normal operating mode, and/or
b) suppressing or automatically acknowledging error diagnosis functions or troubleshooting functions when switching from the energy saving mode to the normal operating mode, and/or
c) providing an error message acknowledgement element when switching from the energy saving mode to the normal operating mode, by means of which multiple error messages can be acknowledged at the same time.

This enables the picking system 1 to be easily transferred from the energy saving mode to the normal operating mode without effortful start-up procedures and extensive interventions on the part of the operating personnel for the picking system 1 being required. Specifically, an automatic or automated start-up of the picking system 1 when switching from the energy saving mode to the normal operating mode is enabled. Therefore, the picking system 1 can be set to an energy saving mode even for relatively short periods of time without this causing major disruptions in the picking procedure.

As represented in FIG. 1, the picking system 1 can be divided into spatially limited zones Z1 . . . Z6. Generally, a zone Z1 . . . Z6 can have a virtual limit, or it can be limited in full or in part by construction measures, as represented in FIG. 1, wherein an access to the zone Z1 . . . Z6 by a person is enabled only at a the article receipts 4a, 4b, at the article issue 5 or at a passage D1 . . . D7. Such construction measures are the walls 2, for example. Yet, generally also other means which cannot be passed by persons or are at least not provided for being passed by a person can be provided in the picking system 1. For example, scaffolding and similar, which, while generally being able to be climbed through or over, are not intended for that purpose, are construction measures that are not intended to be passed by a person.

In the normal operating mode, the zones Z1 . . . Z6 are each supplied with energy by the energy supply system EVS. In this embodiment variant, one, multiple or all zones Z1 . . . Z6 of the zones Z1 . . . Z6 can be switched from the normal operating mode to the energy saving mode and from the energy saving mode to the normal operating mode as required using the energy saving module 21. In the energy saving mode, at least the part of the energy supply system EVS which supplies the respective zone Z1 . . . Z6 or respective zones Z1 . . . Z6 with energy is switched off. Further, the energy saving module 21 in this embodiment variant is configured for
a) masking, suppressing or automatically acknowledging error messages assigned to the zone Z1 . . . Z6 when switching the zone Z1 . . . Z6 from the energy saving mode to the normal operating mode, and/or
b) suppressing or automatically acknowledging error diagnosis functions or troubleshooting functions assigned to the zone Z1 . . . Z6 when switching the zone Z1 . . . Z6 from the energy saving mode to the normal operating mode, and/or
c) providing an error message acknowledgement element when switching from the energy saving mode to the normal operating mode, by means of which multiple error messages assigned to the zone Z1 . . . Z6 can be acknowledged at the same time.

The energy saving module 21 can generally comprise multiple energy switching modules, each of which is assigned to a zone Z1 . . . Z6 of the zones Z1 . . . Z6 and is configured for switching the respective zone Z1 . . . Z6 from the normal operating mode to the energy saving mode and from the energy saving mode to the normal operating mode as required. These energy switching modules can communicate in a wireless or wired manner with a central part of the energy saving module 21. Here, the non-central approach is similar to the approach followed with the submodules 23 of the control system 22. Accordingly, an energy switching module could take the place of the energy saving module 21 in FIG. 2 and be configured for switching the switch 26.

It is further advantageous if the picking system 1 comprises an integrity monitoring device, which is configured for monitoring an integrity of the zone Z1 . . . Z6 in the energy saving mode, wherein the integrity of the zone Z1 . . . Z6 is violated at least whenever the integrity monitoring device detects an access to the zone Z1 . . . Z6 by a person. In the example represented in FIG. 1, the integrity monitoring device comprises in particular the door switches 15a . . . 15c, the light barrier or the light grid 16a, 16b, the surveillance camera 17a, 17 and the motion detectors 18a, 18b. These means can be used to detect the access to a zone Z1 . . . Z6 by a person.

The energy saving module 21 can further be configured for
a) displaying error messages assigned to the zone Z1 . . . Z6 at an output device (for example a screen of the energy saving module 21) when switching the zone Z1 . . . Z6 from the energy saving mode to the normal operating mode if the integrity of the zone Z1 . . . Z6 is violated when switching as specified, and masking, suppressing or automatically acknowledging error messages assigned to the zone Z1 . . . Z6 if the integrity of the zone Z1 . . . Z6 is inviolate when switching as specified, and/or
b) executing error diagnosis functions or troubleshooting functions assigned to the zone Z1 . . . Z6 when switching the zone Z1 . . . Z6 from the energy saving mode to the normal operating mode if the integrity of the zone Z1 . . . Z6 is violated when switching as specified, and suppressing or automatically acknowledging their execution if the integrity of the zone Z1 . . . Z6 is inviolate when switching as specified, and/or
c) displaying error messages assigned to the zone Z1 . . . Z6 at an output device (for example a screen of the energy saving module 21) when switching the zone Z1 . . . Z6 from the energy saving mode to the normal operating mode if the integrity of the zone Z1 . . . Z6 is violated when switching as specified, and providing an error message acknowledgement element when switching from the energy saving mode to the normal operating mode, by means of which multiple error messages assigned to the zone Z1 . . . Z6 can be acknowledged at the same time if the integrity of the zone Z1 . . . Z6 is inviolate when switching as specified.

In this embodiment variant, it is assumed that error messages assigned to the zone Z1 . . . Z6 and/or error diagnosis functions or troubleshooting functions assigned to the zone Z1 . . . Z6 are irrelevant if the integrity of the zone Z1 . . . Z6 is inviolate when switching as specified, i.e. if the zone Z1 . . . Z6 was not entered by a person in the energy saving mode, for example. Accordingly, error messages occurring in the energy saving mode are masked, suppressed and/or automatically acknowledged, or can be acknowledged in a simple manner by actuating the error message acknowledgement element, if the integrity of the zone Z1 . . . Z6 is inviolate when switching from the energy saving mode to the normal operating mode. Equally, error diagnosis functions occurring in the energy saving mode are suppressed or automatically acknowledged if the integrity of the zone Z1 . . . Z6 is inviolate when switching from the energy saving mode to the normal operating mode. This substantially facilitates the switching from the energy saving mode to the normal operating mode for the operating personnel of the picking system 1.

For example, a flag or status bit can be set in the integrity monitoring device or a switching element can be switched on if the integrity of the zone Z1 . . . Z6 is violated. In the latter case, a violation of the integrity can be indicated, for example, by a specific voltage level or a specific signal. The integrity monitoring device can be configured both in software and in hardware and accordingly comprise a computer program and/or an electronic circuit.

FIG. 3 shows a device which is very similar to the device represented in FIG. 2. In contrast to the latter, the device represented in FIG. 3 additionally comprises an emergency stop and/or emergency shutdown actuating element 19, with which the drive M for conveyor rollers 25 of the conveyor 8, the light barrier 16 and in this case also the camera 17 and the lighting 24 can be switched current-free, for example, in an emergency, for example if an operator observes a serious error in the procedures in the picking system 1. Here, the emergency stop and/or emergency shutdown actuating element 19 is arranged in series to the switch 26.

In one embodiment variant, it can be provided that the integrity of the zone Z1 . . . Z6 is violated and remains violated if the emergency stop and/or emergency shutdown actuating element 19 is pushed even once the emergency stop and/or emergency shutdown actuating element 19 is unlocked again. In this embodiment variant, the actuation of the emergency stop and/or emergency shutdown actuating element 19 will result in a violation of the integrity of the zone Z1 . . . Z6 in any case, as its actuation, unless performed abusively, is always a consequence of an observed hazard.

In another embodiment variant, it is therefore provided that the integrity of the zone Z1 . . . Z6 is violated only as long as the emergency stop and/or emergency shutdown actuating element 19 is pushed or locked. In this case, it is assumed that the actuation of the emergency stop and/or emergency shutdown actuating element 19 is relevant only as long as the emergency stop and/or emergency shutdown actuating element 19 is pushed or locked and an observed hazard is no longer relevant once the emergency stop and/or emergency shutdown actuating element 19 is released or unlocked.

It is also conceivable that an integrity acknowledgement element is provided, which resets a violated integrity of the zone Z1 . . . Z6 upon actuation. This enables persons who enter a zone Z1 . . . Z6 in an energy saving mode but ensure that no changes were made in the zone Z1 . . . Z6 to reset a violated integrity. For example, such a person can be a night porter inspecting a zone Z1 . . . Z6. The integrity acknowledgement element can be part of the control system 22 and be designed, for example, as an acknowledgement button or acknowledgement function and configured both in software and in hardware.

As mentioned above, it can be provided that the control system 22 comprises a submodule 23 with a voltage monitoring device 27 which is configured for detecting a failure of a supply voltage for the submodule 23 and displaying the failure of a supply voltage by an error message also after the supply voltage has been switched on again. This is to prevent inexplicable errors in the respective part of the control system 22 due to a temporary drop in the supply voltage. Instead, a failure of a supply voltage can be identified at any time, even if it is only temporary.

FIG. 4 shows a possible realization of such a voltage monitoring device 27. The voltage monitoring device 27 comprises a threshold value switch 28, an RS Flip Flop 29, an OR gate 30 and a signal lamp 31.

A supply voltage Uv for the submodule 23 is applied to the negative input of the threshold value switch 28. This supply voltage Uv is matched against a reference voltage URef applied to the positive input of the threshold value switch 28. If the supply voltage Uv falls below the reference voltage URef, this will result in a positive slope at the output of the threshold value switch 28 and therefore in a positive slope at the set input S of the RS Flip Flop 29. This sets the RS Flip Flop 29, which results in a positive output signal at the output Q of the RS Flip Flop 29, which makes the signal lamp 31 light up. Even an increase in the supply voltage Uv above the reference voltage URef will not change this, as the RS Flip Flop 29 will maintain its switching state even then. In this example, the RS Flip Flop 29 can be reset again only by exerting pressure on the button T or by an external acknowledgement signal EXT. To that end, a switching signal originating from the button T and the external acknowledgement signal EXT are applied to the input of the OR gate 30. The output of the OR gate 30 is applied to the reset input R of the RS Flip Flop 29, whereby the RS Flip Flop 29 can be reset and whereby subsequently also the signal lamp 31 goes out. A singular detected fall in the supply voltage Uv is therefore displayed until the error has been acknowledged. Here, FIG. 4 is merely to illustrate the logical functioning of such a voltage monitoring device 27, which can evidently also be realized in a different manner and in particular comprise components in software. It should be noted in this context that the acknowledgement signal EXT should not be mixed up with or equated to the integrity acknowledgement element for resetting a violated integrity of a zone Z1 . . . Z6 and resets, instead, only the displaying of a detected failure or decrease in the supply voltage Uv.

The energy saving module 21 is further configured for
a) masking, suppressing and/or automatically acknowledging error messages relating to said failure of the supply voltage Uv when switching from the energy saving mode to the normal operating mode, and/or
b) suppressing or automatically acknowledging error diagnosis functions relating to said failure of the supply voltage Uv when switching from the energy saving mode to the normal operating mode, and/or
c) providing an error message acknowledgement element when switching from the energy saving mode to the normal operating mode, by means of which multiple error messages relating to said failure of the supply voltage Uv can be acknowledged at the same time.

This ensures that error messages which can be attributed to a failure of the supply voltage Uv knowingly caused by switching to the energy saving mode are masked, suppressed and/or automatically acknowledged or can be acknowledged in a simple manner by actuating the error message acknowledgement element when switching from the energy saving mode to the normal operating mode. Equally, error diagnosis functions which can be attributed to a knowingly caused failure of the supply voltage Uv are suppressed or automatically acknowledged when switching from the energy saving mode to the normal operating mode. Accordingly, the switching from the energy saving mode to the normal operating mode is facilitated substantially for the operating personnel of the picking system 1. For example, the external signal EXT can be generated by the energy saving module 21 automatically to that end.

It is also conceivable to combine the measures proposed in relation to a shut-down of a zone Z1 . . . Z6 and the measures proposed in relation to a voltage monitoring device. The general result will then be a picking system 1
in which the control system 22 comprises a submodule 23 with a voltage monitoring device 27, which is configured for detecting a failure of a supply voltage Uv for the submodule 23 and displaying the failure of a supply voltage Uv by an error message also after the supply voltage has been switched on again, and
in which the energy saving module 21 is configured for
a) masking, suppressing and/or automatically acknowledging error messages assigned to the zone Z1 . . . Z6 and relating to said failure of the supply voltage Uv when switching the zone Z1 . . . Z6 from the energy saving mode to a normal operating mode, and/or
b) suppressing or automatically acknowledging error diagnosis functions assigned to the zone Z1 . . . Z6 and relating to said failure of the supply voltage Uv when switching the zone Z1 . . . Z6 from the energy saving mode to the normal operating mode, and/or
c) providing an error message acknowledgement element when switching from the energy saving mode to the normal operating mode, by means of which multiple error messages assigned to the zone Z1 . . . Z6 and relating to said failure of the supply voltage Uv can be acknowledged at the same time.

It is further conceivable to combine the measures proposed for the integrity monitoring device and the measures proposed in relation to a voltage monitoring device 27. The general result will then be a picking system 1 in which - the picking system 1 comprises an integrity monitoring device, which is configured for monitoring an integrity of the zone Z1 . . . Z6 in the energy saving mode, wherein the integrity of the zone Z1 . . . Z6 is violated at least whenever the integrity monitoring device detects an access to the zone Z1 . . . Z6 by a person, and - the control system comprises a submodule 23 with a voltage monitoring device 27, which is configured for detecting a failure of a supply voltage Uv for the submodule 23 and displaying the failure of a supply voltage Uv by an error message also after the supply voltage has been switched on again.

As mentioned above, the integrity monitoring device can comprise in particular the door switches 15a . . . 15c, the light barrier or the light grid 16a, 16b, the surveillance camera 17a, 17 and the motion detectors 18a, 18b.

In one embodiment variant, it can be provided that the energy saving module is configured for
a) displaying error messages assigned to the zone Z1 . . . Z6, including error messages relating to said failure of the supply voltage Uv, when switching the zone Z1 . . . Z6 from the energy saving mode to a normal operating mode if the integrity of the zone Z1 . . . Z6 is violated when switching as specified, and masking, suppressing or automatically acknowledging error messages assigned to the zone Z1 . . . Z6, including error messages relating to said failure of the supply voltage Uv, if the integrity of the zone Z1 . . . Z6 is inviolate when switching as specified, and/or
b) executing error diagnosis functions or troubleshooting functions assigned to the zone Z1 . . . Z6, including error diagnosis functions relating to said failure of the supply voltage Uv, when switching the zone Z1 . . . Z6 from the energy saving mode to the normal operating mode if the integrity of the zone Z1 . . . Z6 is violated when switching as specified, and suppressing or automatically acknowledging their execution if the integrity of the zone Z1 . . . Z6 is inviolate when switching as specified, and/or
c) displaying error messages assigned to the zone Z1 . . . Z6, including error messages relating to said failure of the supply voltage Uv, when switching the zone Z1 . . . Z6 from the energy saving mode to a normal operating mode if the integrity of the zone Z1 . . . Z6 is violated when switching as specified, and providing an error message acknowledgement element when switching from the energy saving mode to the normal operating mode, by means of which multiple error messages assigned to the zone Z1 . . . Z6, including error messages relating to said failure of the supply voltage Uv, can be acknowledged at the same time if the integrity of the zone Z1 . . . Z6 is inviolate when switching as specified.

In this embodiment variant, the error messages relating to said failure of the supply voltage Uv are treated the same as all other error messages.

In an alternative embodiment variant, it can also be provided that the energy saving module is configured for
a) displaying error messages assigned to the zone Z1 . . . Z6, excluding error messages relating to said failure of the supply voltage Uv, when switching the zone Z1 . . . Z6 from the energy saving mode to a normal operating mode if the integrity of the zone Z1 . . . Z6 is violated when switching as specified, and masking, suppressing or automatically acknowledging error messages assigned to the zone Z1 . . . Z6, excluding error messages relating to said failure of the supply voltage Uv, if the integrity of the zone Z1 . . . Z6 is inviolate when switching as specified, and masking, suppressing or automatically acknowledging error messages assigned to the zone Z1 . . . Z6 and relating to said failure of the supply voltage Uv when switching the zone Z1 . . . Z6 from the energy saving mode to a normal operating mode independent of the integrity of the zone Z1 . . . Z6 when switching as specified, and/or
b) executing error diagnosis functions or troubleshooting functions assigned to the zone Z1 . . . Z6, excluding error diagnosis functions relating to said failure of the supply voltage Uv, when switching the zone Z1 . . . Z6 from the energy saving mode to the normal operating mode if the integrity of the zone Z1 . . . Z6 is violated when switching as specified, and suppressing or automatically acknowledging their execution if the integrity of the zone Z1 . . . Z6 is inviolate when switching as specified, and suppressing or automatically acknowledging error diagnosis functions assigned to the zone Z1 . . . Z6 and relating to said failure of the supply voltage Uv when switching the zone Z1 . . . Z6 from the energy saving mode to the normal operating mode independent of the integrity of the zone Z1 . . . Z6 when switching as specified, and/or
c) displaying error messages assigned to the zone Z1 . . . Z6, excluding error messages relating to said failure of the supply voltage Uv, when switching the zone Z1 . . . Z6 from the energy saving mode to a normal operating mode if the integrity of the zone Z1 . . . Z6 is violated when switching as specified, and providing an error message acknowledgement element when switching from the energy saving mode to the normal operating mode, by means of which multiple error messages assigned to the zone Z1 . . . Z6, excluding error messages relating to said failure of the supply voltage Uv, can be acknowledged at the same time if the integrity of the zone Z1 . . . Z6 is inviolate when switching as specified, and by means of which multiple error messages assigned to the zone Z1 . . . Z6 and relating to said failure of the supply voltage Uv can be acknowledged independent of the integrity of the zone Z1 . . . Z6 when switching as specified. In this embodiment variant, the error messages relating to said failure of the supply voltage Uv are treated differently from all other error messages. Specifically, error messages assigned to the zone Z1 . . . Z6 which can be attributed to a failure of the supply voltage Uv knowingly caused by switching to the energy saving mode are always masked, suppressed and/or automatically acknowledged or can be acknowledged in a simple manner by actuating the error message acknowledgement element when switching from the energy saving mode to the normal operating mode. Equally, error diagnosis functions which can be attributed to a knowingly caused failure of the supply voltage Uv are always suppressed or automatically acknowledged when switching from the energy saving mode to the normal operating mode.

The picking system 1 can additionally also comprise a safety system supplied with energy by the energy supply system EVS, wherein in the energy saving mode, at least part of the energy supply system EVS for the safety system is switched off. Such a safety system can comprise, for example, the camera 17 from FIGS. 2 and 3. This camera 17 can be provided not only for detecting lying articles 9a . . . 9g on the conveyor 8 but can also trigger an alarm message if the drive M of the conveyor 8 is switched off and a signal can therefore not originate from a lying article 9a . . . 9g. If such a camera 17 is in the energy saving mode in a zone Z1 . . . Z6, the camera 17 can be switched off if the integrity of the zone Z1 . . . Z6 is established in another manner. A safety system which acts not only upon the switched-off zone Z1 . . . Z6 can also remain switched on. For example, this may be parts of an alarm system, with which the picking system 1 is monitored.

It can generally be provided that the energy saving module 21 is configured for
a) masking, suppressing or automatically acknowledging all error messages, in particular all error messages assigned to a zone Z1 . . . Z6, when switching from the energy saving mode to a normal operating mode, and/or
b) suppressing or automatically acknowledging all error diagnosis functions or troubleshooting functions, in particular all error diagnosis functions or troubleshooting functions assigned to a zone Z1 . . . Z6, when switching from the energy saving mode to the normal operating mode, and/or
c) providing an error message acknowledgement element when switching from the energy saving mode to the normal operating mode, by means of which all error messages, in particular all error messages assigned to a zone Z1 . . . Z6, can be acknowledged at the same time.

This enables the switching from the energy saving mode to the normal operating mode to be executed with a particularly low effort.

Yet, it would also be conceivable that the picking system 1
comprises a selecting module, which is configured for acquiring a selection of error messages, error diagnosis functions or troubleshooting functions, in particular a selection of error messages, error diagnosis functions or troubleshooting functions which are assigned to a zone Z1 . . . Z6, and
the energy saving module 21 is configured for
a) excepting the selected error messages from being masked, suppressed or automatically acknowledged when switching from the energy saving mode to a normal operation, and/or
b) excepting the selected error diagnosis functions or troubleshooting functions from being suppressed or automatically acknowledged when switching from the energy saving mode to the normal operation, and/or
c) providing an error message acknowledgement element when switching from the energy saving mode to the normal operating mode, wherein the selected error messages are excepted from being acknowledged by the error message acknowledgement element at the same time.

For example, the selecting module can be part of the energy saving module 21 and in particular be configured in software. In an input mask of the selecting module, those error messages which are not to be masked, suppressed or automatically acknowledged and/or are not to be acknowledgeable by the error message acknowledgement element when switching from the energy saving mode to a normal operation can be actively selected in cases a) and c) and those error diagnosis functions or troubleshooting functions which are not to be suppressed or automatically acknowledged when switching from the energy saving mode can be actively selected in case b). Points a), b) and c) can also relate to a negative selection (i.e. deselection), for example if, in an input mask of the selecting module, those error messages which are to be masked, suppressed or automatically acknowledged and/or are to be acknowledgeable by the error message acknowledgement element when switching from the energy saving mode to a normal operation are actively selected in cases a) and c) and those error diagnosis functions or troubleshooting functions which are to be suppressed or automatically acknowledged when switching from the energy saving mode are actively selected in case b).

Finally, it should be noted that the scope of protection is determined by the claims. However, the description and the drawings are to be adduced for construing the claims. Individual features or feature combinations from the different exemplary embodiments shown and described may represent independent inventive solutions. The object underlying the independent in5 ventive solutions may be gathered from the description.

In particular, it should also be noted that, in reality, the depicted devices can also comprise more, or also fewer, components than depicted. In some cases, the shown devices and/or their components may not be depicted to scale and/or be enlarged and/or reduced in size.

Table of reference numbers

| | |
|---|---|
| 1 | picking system |
| 2 | wall |
| 3a, 3b | article storage |
| 4a, 4b | article receipt |
| 5 | article issue |
| 6 | rack |
| 7a, 7b | storage and retrieval unit |
| 8a..8e | conveyor |
| 9a..9h | lying articles |
| 10 | overhead conveyor |
| 11 | hanging articles |
| 12a..12c | autonomous guided vehicle |
| 13a..13c | robot |
| 14 | picking station |
| 15a..15c | door switch (integrity monitoring device) |
| 16a, 16b | light barrier/light grid (integrity monitoring device) |
| 17a, 17b | surveillance camera (integrity monitoring device) |
| 18a, 18b | motion detector (integrity monitoring device) |
| 19a..19e | emergency stop and/or emergency shutdown actuating element |
| 20 | controller |
| 21 | energy saving module |
| 22 | control system |
| 23 | submodule of the control system |
| 24 | lighting |
| 25 | conveyor roller |
| 26 | switch |
| 27 | voltage monitoring device |
| 28 | threshold value switch |
| 29 | RS Flip Flop |
| 30 | OR gate |
| 31 | signal lamp |
| D1..D7 | passage |
| EVS | energy supply system |
| EXT | external acknowledgement signal |
| M | drive/drive system |
| Q | output |
| R | reset input |
| S | set input |
| T | button |
| URef | reference voltage |
| Uv | supply voltage |
| Z1..Z6 | zone |

1. A picking system including an article storage, a picking station, a conveying system for transporting articles between the article storage and the picking station, a drive system for the conveying system, a control system for the conveying system and an energy supply system, which is configured for supplying the drive system and the control system with energy,
wherein the picking system comprises an electronic energy saving module, with which the picking system can be switched from a normal operating mode to an energy saving mode and from the energy saving mode to the normal operating mode, wherein in the energy saving mode, at least a part of the energy supply system is switched off,
wherein the energy saving module is configured for:
a) masking, suppressing or automatically acknowledging error messages when switching from the energy saving mode to the normal operating mode, and/or
b) suppressing or automatically acknowledging error diagnosis functions or troubleshooting functions when switching from the energy saving mode to the normal operating mode, and/or
c) providing an error message acknowledgement element when switching from the energy saving mode to the normal operating mode, by means of which multiple error messages can be acknowledged at the same time.

2. The picking system according to claim 1, wherein
the control system comprises a submodule with a voltage monitoring device, which is configured for detecting a failure of a supply voltage for the submodule and displaying the failure of a supply voltage by an error message also after the supply voltage has been switched on again, and
the energy saving module is configured for:
a) masking, suppressing and/or automatically acknowledging error messages relating to said failure of the supply voltage when switching from the energy saving mode to the normal operating mode, and/or
b) suppressing or automatically acknowledging error diagnosis functions relating to said failure of the supply voltage when switching from the energy saving mode to the normal operating mode, and/or
c) providing an error message acknowledgement element when switching from the energy saving mode to the normal operating mode, by means of which multiple error messages relating to said failure of the supply voltage can be acknowledged at the same time.

3. The picking system according to claim 1, wherein
the picking system is divided into spatially limited zones, each of which is supplied with energy by the energy supply system in the normal operating mode, and
the energy saving module is configured for switching one, multiple or all zones of the zones from the normal operating mode to the energy saving mode and from the energy saving mode to the normal operating mode as required, wherein in the energy saving mode, at least the part of the energy supply system which supplies the respective zone or zones with energy is switched off,
and the energy saving module is configured for:
a) masking, suppressing or automatically acknowledging error messages assigned to the zone when switching the zone from the energy saving mode to the normal operating mode, and/or
b) suppressing or automatically acknowledging error diagnosis functions or troubleshooting functions assigned to the zone when switching the zone from the energy saving mode to the normal operating mode, and/or
c) providing an error message acknowledgement element when switching from the energy saving mode to the normal operating mode, by means of which multiple error messages assigned to the zone can be acknowledged at the same time.

4. The picking system according to claim 3, wherein the energy saving module comprises multiple energy switching modules, each of which is assigned to a zone of the zones and configured for switching the respective zone from the normal operating mode to the energy saving mode and from the energy saving mode to the normal operating mode as required.

5. The picking system according to claim 3, wherein
the picking system comprises an integrity monitoring device, which is configured for monitoring an integrity of the zone in the energy saving mode, wherein the integrity of the zone is violated at least whenever the integrity monitoring device detects an access to the zone by a person, and
the energy saving module is configured for:
a) displaying error messages assigned to the zone at an output device when switching the zone from the energy saving mode to the normal operating mode if the integrity of the zone is violated when switching as specified, and masking, suppressing and/or automatically acknowledging error messages assigned to the zone if the integrity of the zone is inviolate when switching as specified, and/or
b) executing error diagnosis functions or troubleshooting functions assigned to the zone when switching the zone from the energy saving mode to the normal operating mode if the integrity of the zone is violated when switching as specified, and suppressing or automatically acknowledging their execution if the integrity of the zone is inviolate when switching as specified, and/or
c) displaying error messages assigned to the zone at an output device when switching the zone from the energy saving mode to the normal operating mode if the integrity of the zone is violated when switching as specified, and providing an error message acknowledgement element when switching from the energy saving mode to the normal operating mode, by means of which multiple error messages assigned to the zone can be acknowledged at the same time if the integrity of the zone is inviolate when switching as specified.

6. The picking system according to claim 3, wherein
the control system comprises a submodule with a voltage monitoring device, which is configured for detecting a failure of a supply voltage for the submodule and displaying the failure of a supply voltage by an error message also after the supply voltage has been switched on again, and
the energy saving module is configured for:
a) masking, suppressing and/or automatically acknowledging error messages assigned to the zone and relating to said failure of the supply voltage when switching the zone from the energy saving mode to a normal operating mode, and/or
b) suppressing or automatically acknowledging error diagnosis functions assigned to the zone and relating to said failure of the supply voltage when switching the zone from the energy saving mode to the normal operating mode, and/or
c) providing an error message acknowledgement element when switching from the energy saving mode to the normal operating mode, by means of which multiple error messages assigned to the zone and relating to said failure of the supply voltage can be acknowledged at the same time.

7. The picking system according to claim 3, wherein
the picking system comprises an integrity monitoring device, which is configured for monitoring an integrity of the zone in the energy saving mode, wherein the integrity of the zone is violated at least whenever the integrity monitoring device detects an access to the zone by a person,
the control system comprises a submodule with a voltage monitoring device, which is configured for detecting a failure of a supply voltage for the submodule and displaying the failure of a supply voltage by an error message also after the supply voltage has been switched on again, and
the energy saving module is configured for:
a) displaying error messages assigned to the zone, including error messages relating to said failure of the supply voltage, when switching the zone from the energy saving mode to a normal operating mode if the integrity of the zone is violated when switching as specified, and masking, suppressing or automatically acknowledging error messages assigned to the zone, including error messages relating to said failure of the supply voltage, if the integrity of the zone is inviolate when switching as specified, and/or
b) executing error diagnosis functions or troubleshooting functions assigned to the zone, including error diagnosis functions relating to said failure of the supply voltage, when switching the zone from the energy saving mode to the normal operating mode if the integrity of the zone is violated when switching as specified, and suppressing or automatically acknowledging their execution if the integrity of the zone is inviolate when switching as specified, and/or
c) displaying error messages assigned to the zone, including error messages relating to said failure of the supply voltage, when switching the zone from the energy saving mode to a normal operating mode if the integrity of the zone is violated when switching as specified, and providing an error message acknowledgement element when switching from the energy saving mode to the normal operating mode, by means of which multiple error messages assigned to the zone, including error messages relating to said failure of the supply voltage, can be acknowledged at the same time if the integrity of the zone is inviolate when switching as specified.

8. The picking system according to claim 3, wherein
the picking system comprises an integrity monitoring device, which is configured for monitoring an integrity of the zone in the energy saving mode, wherein the integrity of the zone is violated at least whenever the integrity monitoring device detects an access to the zone by a person,
the control system comprises a submodule with a voltage monitoring device, which is configured for detecting a failure of a supply voltage for the submodule and displaying the failure of a supply voltage by an error message also after the supply voltage has been switched on again, and
the energy saving module is configured for:
a) displaying error messages assigned to the zone, excluding error messages relating to said failure of the supply voltage, when switching the zone from the energy saving mode to a normal operating mode if the integrity of the zone is violated when switching as specified, and masking, suppressing or automatically acknowledging error messages assigned to the zone, excluding error messages relating to said failure of the supply voltage, if the integrity of the zone is inviolate when switching as specified, and masking, suppressing or automatically acknowledging error messages assigned to the zone and relating to said failure of the supply voltage when switching the zone from the energy saving mode to a normal operating mode independent of the integrity of the zone when switching as specified, and/or
b) executing error diagnosis functions or troubleshooting functions assigned to the zone, excluding error diagnosis functions relating to said failure of the supply voltage, when switching the zone-from the energy saving mode to the normal operating mode if the integrity of the zone is violated when switching as specified, and suppressing or automatically acknowledging their execution if the integrity of the zone is inviolate when switching as specified, and suppressing or automatically acknowledging error diagnosis functions assigned to the zone and relating to said failure of the supply voltage when switching the zone from the energy saving mode to the normal operating mode independent of the integrity of the zone when switching as specified, and/or
c) displaying error messages assigned to the zone, excluding error messages relating to said failure of the supply voltage, when switching the zone from the energy saving mode to a normal operating mode if the integrity of the zone is violated when switching as specified, and providing an error message acknowledgement element when switching from the energy saving mode to the normal operating mode, by means of which multiple error messages assigned to the zone, excluding error messages relating to said failure of the supply voltage, can be acknowledged at the same time if the integrity of the zone is inviolate when switching as specified, and by means of which multiple error messages assigned to the zone and relating to said failure of the supply voltage can be acknowledged independent of the integrity of the zone when switching as specified.

9. The picking system according to te claim 5, wherein an integrity acknowledgement element is configured for resetting a violated integrity of the zone upon actuation.

10. The picking system according to claim 5, wherein the integrity monitoring device comprises at least one of a door switch, a light barrier, a light grid, a surveillance camera and/or a motion detector for monitoring an access to the zone by a person in the energy saving mode.

11. The picking system according to claim 5, wherein
the integrity monitoring device comprises an emergency stop and/or emergency shutdown actuating element acting upon the energy supply of the zone, and
the integrity of the zone is violated and remains violated if the emergency stop and/or emergency shutdown actuating element is pushed even once the emergency stop and/or emergency shutdown actuating element is unlocked again.

12. The picking system according to the claim 5, characterized in that wherein
the integrity monitoring device comprises an emergency stop and/or emergency shutdown actuating element acting upon the energy supply of the zone, and
the integrity of the zone is violated only as long as the emergency stop and/or emergency shutdown actuating element is pushed or locked.

13. The picking system according to claim 1, wherein the picking system additionally comprises a safety system supplied with energy by the energy supply system, wherein in the energy saving mode, at least a part of the energy supply system for the safety system is switched off.

14. The picking system according to claim 3, wherein the zones are limited by construction measures, wherein an access to the zone by a person is enabled only at a passage.

15. The picking system according to claim 1, characterized in that wherein the energy saving module is configured for;
a) masking, suppressing or automatically acknowledging all error messages, in particular all error messages assigned to a zone, when switching from the energy saving mode to a normal operating mode, and/or
b) suppressing or automatically acknowledging all error diagnosis functions or troubleshooting functions, in particular all error diagnosis functions or troubleshooting functions assigned to a zone, when switching from the energy saving mode to the normal operating mode, and/or
c) providing an error message acknowledgement element when switching from the energy saving mode to the normal operating mode, by means of which all error messages, in particular all error messages assigned to a zone, can be acknowledged at the same time.

16. The picking system according to claim 1, wherein the picking system
comprises a selecting module, which is configured for acquiring a selection of error messages, error diagnosis functions or troubleshooting functions, in particular a selection of error messages, error diagnosis functions or troubleshooting functions which are assigned to a zone, and
the energy saving module is configured for:
a) excepting the selected error messages from being masked, suppressed or automatically acknowledged when switching from the energy saving mode to a normal operation, and/or
b) excepting the selected error diagnosis functions or troubleshooting functions from being suppressed or automatically acknowledged when switching from the energy saving mode to the normal operation, and/or
c) providing an error message acknowledgement element when switching from the energy saving mode to the normal operating mode, wherein the selected error messages are excepted from being acknowledged by the error message acknowledgement element at the same time.

17. A method for switching from an energy saving mode to a normal operating mode in a picking system with an article storage, a picking station, a conveying system for transporting articles between the article storage and the picking station, a drive system for the conveying system, a control system for the conveying system and an energy supply system, which is configured for supplying the drive system and the control system with energy, wherein in the energy saving mode, at least a part of the energy supply system is switched off, wherein
the picking system is switched from the energy saving mode to the normal operating mode with an electronic energy saving module, and
a) error messages are masked, suppressed or automatically acknowledged by the energy saving module when switching from the energy saving mode to the normal operating mode, and/or
b) error diagnosis functions or troubleshooting functions are suppressed or automatically acknowledged by the energy saving module when switching from the energy saving mode to the normal operating mode, and/or
c) an error message acknowledgement element is provided by the energy saving module when switching from the energy saving mode to the normal operating mode, by means of which multiple error messages can be acknowledged at the same time.

18. The method according to claim 17, wherein
the control system comprises a submodule with a voltage monitoring device, which detects a failure of a supply voltage for the submodule and displays the failure of a supply voltage by an error message also after the supply voltage has been switched on again, and
the energy saving module;
a) masks, suppresses and/or automatically acknowledges error messages relating to said failure of the supply voltage when switching from the energy saving mode to the normal operating mode, and/or
b) suppresses or automatically acknowledges error diagnosis functions relating to said failure of the supply voltage when switching from the energy saving mode to the normal operating mode, and/or
c) provides an error message acknowledgement element when switching from the energy saving mode to the normal operating mode, by means of which multiple error messages relating to said failure of the supply voltage can be acknowledged at the same time.

19. The method according to claim 17, wherein
the picking system is divided into spatially limited zones, each of which is supplied with energy by the energy supply system in the normal operating mode, and
the energy saving module switches one, multiple or all zones of the zones from the normal operating mode to the energy saving mode and from the energy saving mode to the normal operating mode as required, wherein in the energy saving mode, at least the part of the energy supply system which supplies the respective zone or zones with energy is switched off,
and the energy saving module;
a) masks, suppresses or automatically acknowledges error messages assigned to the zone when switching the zone from the energy saving mode to the normal operating mode, and/or
b) suppresses or automatically acknowledges error diagnosis functions or troubleshooting functions assigned to the zone when switching the zone from the energy saving mode to the normal operating mode, and/or
c) provides an error message acknowledgement element when switching from the energy saving mode to the normal operating mode, by means of which multiple error messages assigned to the zone can be acknowledged at the same time.

20. The method according to claim 19, wherein the energy saving module comprises multiple energy switching modules, each of which is assigned to a zone of the zones, wherein one or multiple zones are switched from the normal operating mode to the energy saving mode and from the energy saving mode to the normal operating mode, as required, by the respectively assigned energy switching module.

21. The method according to claim 19, wherein
the picking system comprises an integrity monitoring device, which monitors an integrity of the zone in the energy saving mode, wherein the integrity of the zone is violated at least whenever the integrity monitoring device detects an access to the zone by a person, and
the energy saving module:
a) displays error messages assigned to the zone at an output device when switching the zone from the energy saving mode to the normal operating mode if the integrity of the zone is violated when switching as specified, and masks, suppresses and/or automatically acknowledges error messages assigned to the zone if the integrity of the zone is inviolate when switching as specified, and/or
b) executes error diagnosis functions or troubleshooting functions assigned to the zone when switching the zone from the energy saving mode to the normal operating mode if the integrity of the zone is violated when switching as specified, and suppresses or automatically acknowledges their execution if the integrity of the zone is inviolate when switching as specified, and/or
c) displays error messages assigned to the zone at an output device when switching the zone from the energy saving mode to the normal operating mode if the integrity of the zone is violated when switching as specified, and provides an error message acknowledgement element when switching from the energy saving mode to the normal operating mode, by means of which multiple error messages assigned to the zone can be acknowledged at the same time if the integrity of the zone is inviolate when switching as specified.

22. The method according to claim 19, wherein
the control system comprises a submodule with a voltage monitoring device, which detects a failure of a supply voltage for the submodule and displays the failure of a supply voltage by an error message also after the supply voltage has been switched on again, and
the energy saving module;
a) masks, suppresses and/or automatically acknowledges error messages assigned to the zone and relating to said failure of the supply voltage when switching the zone from the energy saving mode to a normal operating mode, and/or
b) suppresses or automatically acknowledges error diagnosis functions assigned to the zone and relating to said failure of the supply voltage when switching the zone from the energy saving mode to the normal operating mode, and/or
c) provides an error message acknowledgement element when switching the zone from the energy saving mode to the normal operating mode, by means of which multiple error messages relating to said failure of the supply voltage can be acknowledged at the same time.

23. The method according to claim 19, wherein
the picking system comprises an integrity monitoring device, which monitors an integrity of the zone in the energy saving mode, wherein the integrity of the zone is violated at least whenever the integrity monitoring device detects an access to the zone by a person,
the control system comprises a submodule with a voltage monitoring device, which detects a failure of a supply voltage for the submodule and displays the failure of a supply voltage by an error message also after the supply voltage has been switched on again, and
the energy saving module:
a) displays error messages assigned to the zone, including error messages relating to said failure of the supply voltage, when switching the zone from the energy saving mode to a normal operating mode if the integrity of the zone is violated when switching as specified, and masks, suppresses and/or automatically acknowledges error messages assigned to the zone, including error messages relating to said failure of the supply voltage, if the integrity of the zone is inviolate when switching as specified, and/or
b) executes error diagnosis functions or troubleshooting functions assigned to the zone, including error diagnosis functions relating to said failure of the supply voltage, when switching the zone from the energy saving mode to the normal operating mode if the integrity of the zone is violated when switching as specified, and suppresses or automatically acknowledges their execution if the integrity of the zone is inviolate when switching as specified, and/or
c) displays error messages assigned to the zone, including error messages relating to said failure of the supply voltage, when switching the zone from the energy saving mode to a normal operating mode if the integrity of the zone is violated when switching as specified, and provides an error message acknowledgement element when switching from the energy saving mode to the normal operating mode, by means of which multiple error messages assigned to the zone, including error messages relating to said failure of the supply voltage, can be acknowledged at the same time if the integrity of the zone is inviolate when switching as specified.

24. The method according to claim 19, wherein
the picking system comprises an integrity monitoring device, which monitors an integrity of the zone in the energy saving mode, wherein the integrity of the zone is violated at least whenever the integrity monitoring device detects an access to the zone by a person,
the control system comprises a submodule with a voltage monitoring device, which detects a failure of a supply voltage for the submodule and displays the failure of a supply voltage by an error message also after the supply voltage has been switched on again, and
the energy saving module:
a) displays error messages assigned to the zone, excluding error messages relating to said failure of the supply voltage, when switching the zone from the energy saving mode to a normal operating mode if the integrity of the zone is violated when switching as specified, and masks, suppresses and/or automatically acknowledges error messages assigned to the zone, excluding error messages relating to said failure of the supply voltage, if the integrity of the zone is inviolate when switching as specified, and masks, suppresses and/or automatically acknowledges error messages assigned to the zone and relating to said failure of the supply voltage when switching the zone from the energy saving mode to a normal operating mode independent of the integrity of the zone when switching as specified, and/or
b) executes error diagnosis functions or troubleshooting functions assigned to the zone, excluding error diagnosis functions relating to said failure of the supply voltage, when switching the zone from the energy saving mode to the normal operating mode if the integrity of the zone is violated when switching as specified, and suppresses or automatically acknowledges their execution if the integrity of the zone is inviolate when switching as specified, and suppresses or automatically acknowledges error diagnosis functions assigned to the zone and relating to said failure of the supply voltage when switching the zone from the energy saving mode to the normal operating mode independent of the integrity of the zone when switching as specified, and/or
c) displays error messages assigned to the zone, excluding error messages relating to said failure of the supply voltage, when switching the zone from the energy saving mode to a normal operating mode if the integrity of the zone is violated when switching as specified, and provides an error message acknowledgement element when switching from the energy saving mode to the normal operating mode, by means of which multiple error messages assigned to the zone, excluding error messages relating to said failure of the supply voltage, can be acknowledged at the same time if the integrity of the zone is inviolate when switching as specified, and by means of which multiple error messages assigned to the zone and relating to said failure of the supply voltage can be acknowledged independent of the integrity of the zone when switching as specified.

25. The method according to claim 21, wherein an integrity acknowledgement element, which resets a violated integrity of the zone upon actuation.

26. The method according to claim 21, wherein
the integrity monitoring device comprises an emergency stop and/or emergency shutdown actuating element acting upon the energy supply of the zone, and
the integrity of the zone is violated and remains violated if the emergency stop and/or emergency shutdown actuating element is pushed even once the emergency stop and/or emergency shutdown actuating element-is unlocked again.

27. The method according to claim 21, wherein
the integrity monitoring device comprises an emergency stop and/or emergency shutdown actuating element acting upon the energy supply of the zone, and
the integrity of the zone is violated only as long as the emergency stop and/or emergency shutdown actuating element is pushed or locked.

28. The method according to claim 17, wherein the energy saving module;
a) masks, suppresses or automatically acknowledges all error messages, in particular all error messages assigned to a zone, when switching from the energy saving mode to a normal operating mode, and/or
b) suppresses or automatically acknowledges all error diagnosis functions or troubleshooting functions, in particular all error diagnosis functions or troubleshooting functions assigned to a zone, when switching from the energy saving mode to the normal operating mode, and/or
c) provides an error message acknowledgement element when switching from the energy saving mode to the normal operating mode, by means of which all error messages, in particular all error messages assigned to a zone, can be acknowledged at the same time.

29. The method according to claim 17, wherein the picking system;
comprises a selecting module, which acquires a selection of error messages, error diagnosis functions or troubleshooting functions, in particular a selection of error messages, error diagnosis functions or troubleshooting functions which are assigned to a zone, and
the energy saving module;
a) excepts the selected error messages from being masked, suppressed or automatically acknowledged when switching from the energy saving mode to a normal operation, and/or
b) excepts the selected error diagnosis functions or troubleshooting functions from being suppressed or automatically acknowledged when switching from the energy saving mode to the normal operation, and/or
c) provides an error message acknowledgement element when switching from the energy saving mode to the normal operating mode, wherein the selected error messages are excepted from being acknowledged by the error message acknowledgement element at the same time.

30. A picking system comprising:
an article storage, a picking station, a conveying system, a drive system for the conveying system, a control system for the conveying system and an energy supply system;
an electronic energy saving module, with which the picking system can be switched from a normal operating mode to an energy saving mode and from the energy saving mode to the normal operating mode, wherein in the energy saving mode, at least a part of the energy supply system is switched off,
wherein the energy saving module is configured to:
a) mask, suppress or automatically acknowledge error messages when switching from the energy saving mode to the normal operating mode, or
b) suppress or automatically acknowledge error diagnosis functions or troubleshooting functions when switching from the energy saving mode to the normal operating mode, or
c) provide an error message acknowledgement element when switching from the energy saving mode to the normal operating mode.
